(19) United States
(12) Patent Application Publication
(10) Pub. No.: US 2005/0100019 A1
(43) Pub. Date: May 12, 2005

(54) Rule based packet processing engine

(76) Inventors: Ravi L. Sahita, Beaverton, OR (US); Priya Rajagopal, Wharton, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/705,608

(22) Filed: Nov. 10, 2003

(51) Int. Cl. H04L 12/56

(52) U.S. Cl. 370/395.2; 370/230

(57) ABSTRACT

The present disclosure relates to the processing of a packet utilizing a generic rule based engine, and, more specifically, to the processing of a packet or stream of packets, which are transmitted across a network, utilizing a generic rule based engine that is part of a network processor.

### BACKGROUND

1. Field

The present disclosure relates to the processing of a packet utilizing a generic rule based engine, and, more specifically, to the processing of a packet or stream of packets, which are transmitted across a network, utilizing a generic rule based engine that is part of a network processor.

2. Background Information

A packet is generally a unit of information typically transmitted as a whole from one part of a network, a source, to another part of a network, a destination. These packets may or may not be of a fixed length. A series, flow or stream of packets taken together may constitute a complete transmission of information across the network.

As packets flow through a network, they may be inspected and processed by various devices along the path from the source to the destination. Packet inspection at an intermediate node is a common part of the network environment. In this environment the need to treat, or process, packets differently is often considered critical in order to ensure the desired quality of service (QoS) and performance requirements of the network to satisfy users. Also, in many cases, security systems, such as, for example, firewalls and intrusion detection services (IDS), frequently inspect packets to detect virus patterns and enforce security policies. Ideally this type of packet processing should have minimal impact on the performance of the network.

A packet is frequently processed using a rule. A “rule” is, in this context, a combination of a set of conditions and associated actions to occur if the conditions are satisfied or met. As rules increase in complexity, more processing is required and the impact on the performance of the network increases. A need therefore exists to improve the efficiency of the processing of rule based packet processing.

### BRIEF DESCRIPTION OF THE DRAWINGS

Subject matter is particularly pointed out and distinctly claimed in the concluding portions of the specification. The disclosed subject matter, however, both as to organization and the method of operation, together with objects, features and advantages thereof, may be best understood by a reference to the following detailed description when read with the accompanying drawings in which:

FIG. 1 is a flowchart illustrating an embodiment of a technique for the processing of a packet utilizing a generic rule based engine in accordance with the disclosed subject matter;

FIG. 2 is a block diagram illustrating an embodiment of an apparatus or memory structures utilized by a technique for the processing of a packet utilizing a generic rule based engine in accordance with the disclosed subject matter;

FIG. 3 is a block diagram illustrating an embodiment of an apparatus or memory structures utilized by a technique for the processing of a packet utilizing a generic rule based engine in accordance with the disclosed subject matter; and

FIG. 4 is a block diagram illustrating an embodiment of a system and apparatus that allows for the processing of a packet utilizing a generic rule based engine in accordance with the disclosed subject matter.

### DETAILED DESCRIPTION

In the following detailed description, numerous details are set forth in order to provide a thorough understanding of the present disclosed subject matter. However, it will be understood by those skilled in the art that the disclosed subject matter may be practiced without these specific details. In other instances, well-known methods, procedures, components, and circuits have not been described in detail so as to not obscure the disclosed subject matter.

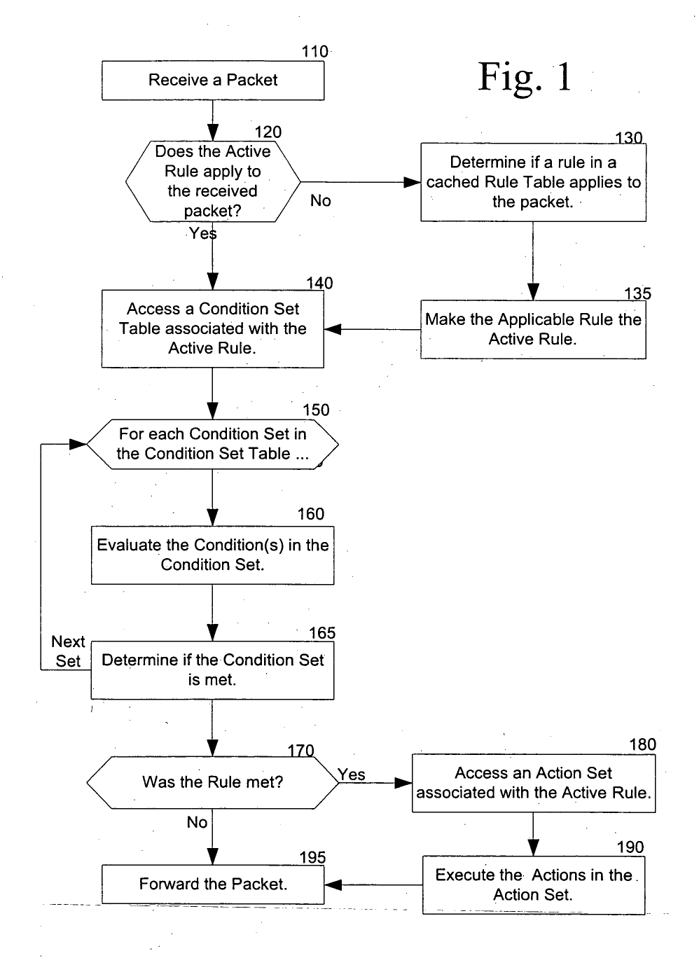

FIG. 1 is a flowchart illustrating an embodiment of a technique for the processing of a packet utilizing a generic rule based engine in accordance with the disclosed subject matter. Block 110 illustrates that a network processor or other device may receive a packet, or flow of packets. In this context, a network processor is a device that inspects and processes packets as they flow across a network. It is contemplated that a network processor may be a specific device, such as, for example, an Intel® Exchange Architecture network processor. Alternatively, in another embodiment, a network processor may be a more generic-use processor configured to act, in at least part, as a network processor. Also, it is contemplated that in one embodiment, the network processor may be combination of devices.

Block 120 illustrates that the packet may be checked to determine if the Active Rule applies to the packet. In one embodiment, the most recently used rule may be cached and considered the Active Rule. In other embodiments, other criteria for establishing the Active Rule may be used. Block 130 illustrates that if the Active Rule is not applicable to the packet, a cached Rules Table may be consulted to determine if any rule applies to the received packet. Block 135 illustrates that, if a rule is applicable, then the Applicable Rule may be made the Active Rule. It is contemplated, that, in one embodiment, Block 120 may be skipped and Block 130 immediately executed. It is also contemplated that, in one embodiment, a packet may have at most one rule which is applicable. In another embodiment, multiple rules may be applicable to the received packet. In such an embodiment, a technique of FIG. 1 may be repeated for each rule.

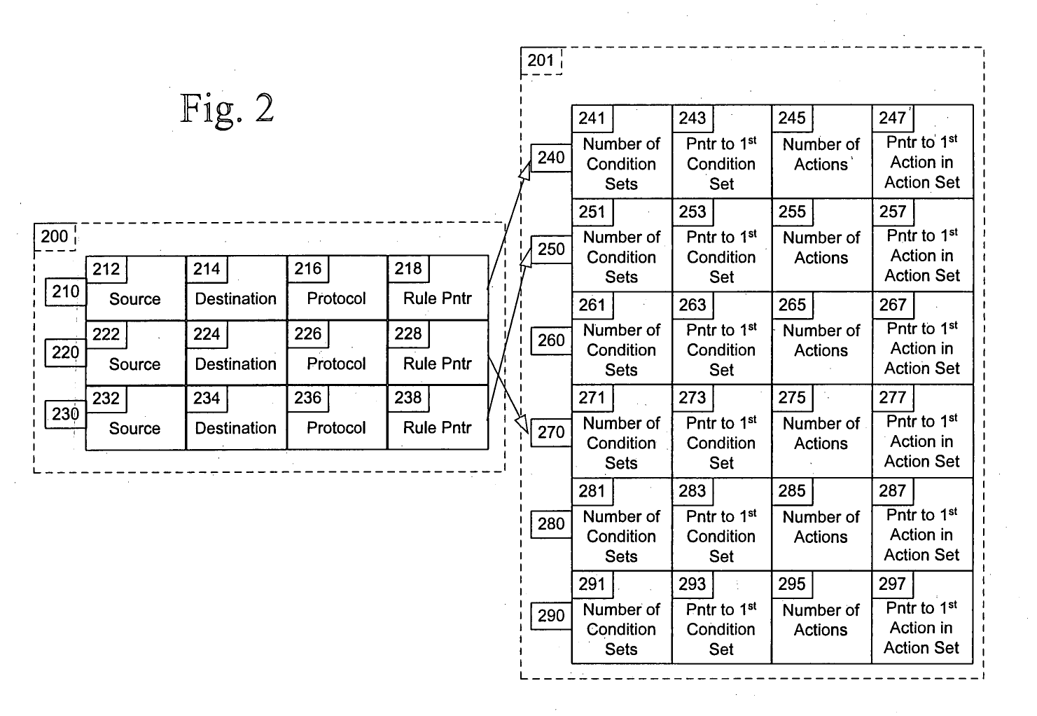

In one embodiment, the applicability of a rule may be determined by utilizing a Rules Table that allows relatively quick comparison to a received packet, as illustrated by FIG. 2. FIG. 2 is a block diagram illustrating an embodiment of an apparatus or memory structures utilized by a technique for the processing of a packet utilizing a generic rule based engine in accordance with the disclosed subject matter. Rules Table 200 may includes a number of rules, or as illustrated abbreviated rules (hereafter “rules”), such as rules 210, 220, & 230. In one embodiment, a rule, for example rule 210, may include all the conditions and actions needed to process the rule. In another embodiment, the Rule Table may only contain rules with enough information to allow the applicability of the rule to be determined by a pointer to the full conditions and actions of the rule. For example, rule 210 only includes a source field 212, destination field 214, protocol field 216, and a rule pointer 218. Rules 220 & 230 includes similar respective fields. However, it is contemplated that other embodiments may include other fields.

In the embodiment illustrated by FIG. 2, a received packet-may be considered applicable to rule 210 if the received packet originated from the source of field 212, is being transmitted to the destination of field 214, and utilizes protocol 216. Likewise, rules 220 & 230 may be considered applicable if their respective fields match the received packet. It is contemplated that in other embodiments of the disclosed subject matter, other criteria for rule applicability may be used. In one embodiment, the Rule Table 200 may be stored within a quickly accessible local memory, for example a Content Addressable Memory (CAM).

In one embodiment, once a rule is determined to be applicable, the rest of the rule may be accessed by looking up the rule's conditions and actions in a Rule Group Table 201. For example, if rule 210 is determined to be applicable to the received packet, the Rule Pointer field 218 may point to Rule Group 240 that contains, or at least facilitates access to the rule's conditions and actions. In the embodiment illustrated by FIG. 2, Rule Group 240 may include a field 241 containing the number of condition sets associated with rule 210, a field 243 containing a pointer to the first condition set, a field 245 containing the number of actions associated with rule 210 and, a field 247 containing a pointer to the first action set. Rule Groups 250, 260, 270, 280, & 290 would include similar respective fields. However, it is contemplated that other embodiments, may integrate the information of the Rule Group table directly within the Rule Table 200 or divide the Rule Group Table into Condition and Action Tables, or other organization. It is contemplated that, in one embodiment, the Rule Group Table may be maintained in a memory structure that is less rapid than the Rule Table.

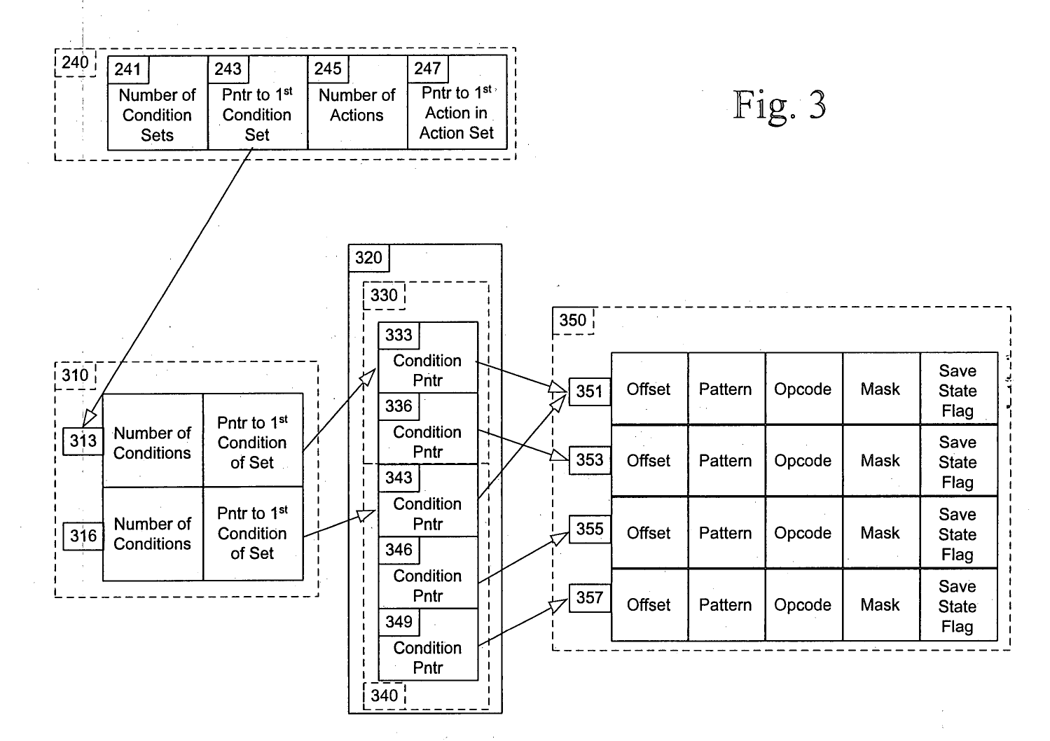

Block 140 of FIG. 1 illustrates that once an Active Rule has been identified, a Condition Set Table associated with the Active Rule may be accessed. The Condition Set Table may allow access to the Condition Sets of the rule. FIG. 3 illustrates one embodiment of a Condition Set Table.

FIG. 3 is a block diagram illustrating an embodiment of an apparatus or memory structures utilized by a technique for the processing of a packet utilizing a generic rule based engine in accordance with the disclosed subject matter. Rule Group 240 may be associated with the Active Rule and include a field 243 that points to the first Condition Set or, in another embodiment, Condition Set Table associated with the Active Rule. In this embodiment, Condition Set Table 310, includes two Condition Sets 313 & 316. Each Condition Set 313 & 316 may include a field denoting the number of Conditions in each Set and a pointer to the first Condition in the respective sets.

In the illustrated embodiment of FIG. 3, the pointer of the Condition Set 310 points to a Condition Indirection Table 320 that holds pointers to the conditions. The Condition Indirection Table may be used to facilitate access to the Conditions as multiple Condition Sets may share identical Conditions. In one embodiment, the Condition Indirection Table may allow the Conditions of a Condition Set to be processed sequentially, but accessed randomly. The Condition Indirection Table may include Condition Set Pointer 330 that contains the pointers for Condition Set 313, and Condition Set Pointer 340 that contains the pointers for Condition Set 316. Of course, other embodiments of the disclosed subject matter are contemplated and this is merely an illustrative embodiment.

In one embodiment, the Condition Set Table or a portion of it may be cached within a Static Random Access Memory (SRAM). In a specific embodiment, the number of total Conditions Sets may be limited by the number of Conditions Sets that may be read in one clock cycle, for example 8, such as is the case for the Intel® IXP2400. However, other embodiments that do not have a limitation on the number of Condition Sets used are contemplated and within the scope of the disclosed subject matter.

Block 150 of FIG. 1 illustrates that for each Condition Set, blocks 160, 170, 180, and 190 may occur. Block 160 illustrates that each Condition of the Active Condition Set may be processed. Block 165 illustrates that if each Condition in the Condition Set is met the Condition Set will be considered to be met. In one embodiment, each Condition is evaluated to obtain a Boolean (“true” or “false”) value. These values may then be logically ANDed together to establish a Boolean value for the Condition Set. In one embodiment, a 1-bit Boolean Condition Accumulator may be used to store the cumulative result of the Condition Set evaluation, which each Condition result being ANDed against the Condition Accumulator as the Condition is evaluated. It is contemplated the other embodiments may logically OR the Conditions or utilize a more complex evaluation scheme.

FIG. 3 illustrates an embodiment of the Condition Sets and Conditions. In one embodiment, Condition Table 350 may store the Conditions 351, 353, 355, & 357. Condition Set 313 may include two Conditions 351 & 353. In the illustrated embodiment, the Conditions are accessed by accessing Condition Set Pointers 330 that uses Condition Pointer 333 to point to Condition 351, and Condition Pointer 336 to point to Condition 353. Condition Set 316 includes three Conditions 351, 355, & 357. In the illustrated embodiment the conditions are accessed utilizing Condition Set Pointers 340 and Condition Pointers 343, 346, & 349, similarly to as just described. However, other implementations and embodiments are contemplated and are within the scope of the disclosed subject matter.

In one embodiment, a Condition, such as, for example Condition 351, may be based on examining the received packet for the presence of a particular pattern. For example, a particular virus pattern could be examined; however, this is merely an illustrative example. To facilitate this examination, the Condition may include, in one embodiment, fields such as, for example, the bit offset at which the pattern is expected to occur, the pattern itself, an opcode denoting the form of examination (e.g. equal to, not equal to, greater than, etc.), a pattern mask to modify the pattern, and an mask operation.

In one embodiment, the Condition may include a Save State Flag that may denote whether or not the Condition has been evaluated for the received packet, and the state of that evaluation. In the illustrated embodiment of FIG. 3, Condition 351 is part of two Condition Sets and therefore would be executed twice. A flag may be used to prevent the needless second execution and return the cached result of the first execution.

In one embodiment, the Condition Table or a portion of it may be cached within a local memory, possibly a Content Addressable Memory (CAM). In a specific embodiment, the number of total Conditions may be limited by the number of entries in the CAM, for example 16, such as is the case for the Intel® IXP2400. However, other embodiments that do not have a limitation on the number of Conditions used are contemplated and within the scope of the disclosed subject matter.

Block 170 of FIG. 1 illustrates that if any of the Conditions Sets were met the Actions Set of the Rule will be performed. As described above, in reference to Block 160, if each Condition in the Condition Set is met the Condition Set will be considered to be met. In one embodiment, each Condition Set is evaluated to obtain a Boolean value. These values may then be logically ORed together to establish a Boolean value for the Rule. This is in contrast to the Conditions that were ANDed in order to establish a Boolean value for the Condition Sets. In one embodiment, a 1-bit Boolean Condition Set Accumulator may be used to store the cumulative result of the Rule evaluation, which each Condition Set result being ORed against the Condition Set Accumulator as the Condition Set is evaluated. It is contemplated the other embodiments may logically AND the Condition Sets or utilize a more complex evaluation scheme.

Block 180 illustrates that, if the Active Rule was met, an Action Set associated with the Active Rule may be accessed. The Action Set may include a number of Actions that are to be preformed on or because of the received packet. It is contemplated that, in one embodiment, the Action Sets may be stored within an Action Set Table. In one embodiment, the Action Set Table may be stored within an SRAM. In a specific embodiment, the number of total Actions within an Action Set may be limited by the number of entries that can be read in one clock cycle, for example 16 32-bit values, such as is the case for the Intel® IXP2400. However, other embodiments that do not have a limitation on the number of Actions used are contemplated and within the scope of the disclosed subject matter.

Block 190 illustrates that each Action in the Active Rule's Action Set may be executed. An action may include things, such as, for example, modifying the packet, providing the packet with high priority throughput, deleting the packet, generating a second packet (possibly to report to an Intrusion Detection System), or report an error; however, these are merely a few illustrative examples to which the disclosed subject matter is not limited.

In one embodiment, the Actions may return a value denoting successful completion or other status. In another embodiment, the Actions in the Actions Set may be chained together and executed sequentially. In another embodiment, the Actions may be executed in substantially simultaneously, or a combination of sequentially and simultaneously.

Block 195 illustrates that the receive packet may be forwarded to its destination or next intermediate node or next packet processing system component. In one embodiment, this block may not be performed if the packet was sufficiently modified or deleted by the Actions of Block 190. In one embodiment, Block 195 may be performed if the Rule was not met in Block 170.

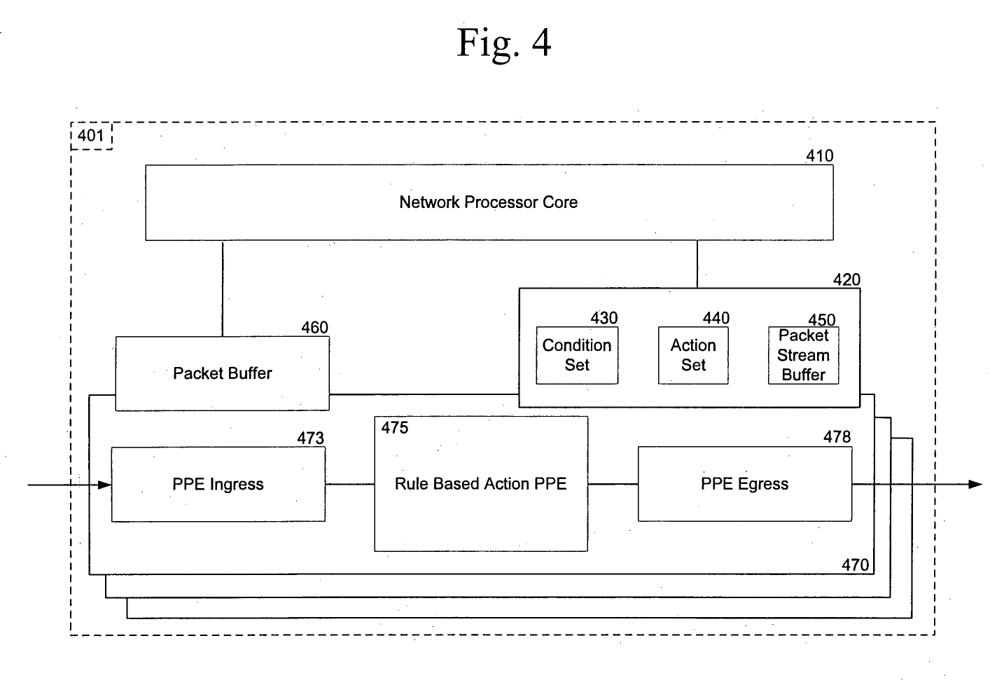

FIG. 4 is a block diagram illustrating an embodiment of a system and apparatus 401 that allows for the processing of a packet utilizing a generic rule based engine in accordance with the disclosed subject matter. In one embodiment, apparatus 401 may include a Network Processor Core 410, a Packet Buffer 460, a cache memory 420, and a Micro-Engine 470. In another embodiment, the apparatus may include a plurality of Micro-Engines operating substantially simultaneously on a plurality of received packets.

Network Processor core 410 may be capable of resource management and receiving a program and control logic from a source external to the apparatus. Packet buffer 460 may be capable of storing and buffering a packet. In one embodiment, once a packet is fully received the packet buffer may release the packet to Packet Processing Engine (PPE) Ingress 473. In another embodiment, the Packet Buffer may copy the packet to the PPE Ingress. In one embodiment, the Packet Buffer may accessible to the plurality of Micro-Engines. In one embodiment, the Packet Buffer may include Dynamic Random Access Memory (DRAM).

In one embodiment, Micro-Engine 470 may include a Packet Processing Engine (PPE) Ingress 473 that is capable of receiving a packet. In one embodiment, the PPE Ingress may also be capable to evaluating the received packet to determine if the Active Rule is applicable; however, in another embodiment, the PPE Ingress may merely be a storage location. The Micro-engine may also include a Rule Based Action PPE 475. The Rule Based Action PPE may be capable of performing a technique as illustrated by FIG. 1 and discussed above. In one embodiment, the Rule Based Action PPE may include a local memory and a Content Addressable Memory (CAM) that is capable of storing the memory structures described above. The Micro-engine may also include a PPE Egress 478 that is capable to storing a packet that has been processed by the Rule Based Action PPE.

In one embodiment, the cache memory 420 may include data structures Condition Set 430, and Action Set 440 which are described in detail above. In one embodiment, the Micro-Engine 470 may have access to the cache memory. In one embodiment, the plurality of Micro-Engines may all have access to the cache memory and the data structures includes within. In one embodiment, the cache memory may also include a Packet Stream Buffer 450 that is capable to storing information and, in some embodiments, previous packets from the same packet stream as the received packet. In one embodiment the cache memory may include SRAM.

The techniques described herein are not limited to any particular hardware or software configuration; they may find applicability in any computing or processing environment. The techniques may be implemented in hardware, software, firmware or a combination thereof. The techniques may be implemented in programs executing on programmable machines such as mobile or stationary computers, personal digital assistants, and similar devices that each include a processor, a storage medium readable or accessible by the processor (including volatile and non-volatile memory and/or storage elements), at least one input device, and one or more output devices. Program code is applied to the data entered using the input device to perform the functions described and to generate output information. The output information may be applied to one or more output devices.

Each program may be implemented in a high level procedural or object oriented programming language to communicate with a processing system. However, programs may be implemented in assembly or machine language, if desired. In any case, the language may be compiled or interpreted.

Each such program may be stored on a storage medium or device, e.g. compact disk read only memory (CD-ROM), digital versatile disk (DVD), hard disk, firmware, non-volatile memory, magnetic disk or similar medium or device, that is readable by a general or special purpose programmable machine for configuring and operating the machine when the storage medium or device is read by the computer to perform the procedures described herein. The system may also be considered to be implemented as a machine-readable or accessible storage medium, configured with a program, where the storage medium so configured causes a machine to operate in a specific manner. Other embodiments are within the scope of the following claims.

While certain features of the disclosed subject matter have been illustrated and described herein, many modifications, substitutions, changes, and equivalents will now occur to those skilled in the art. It is, therefore, to be understood that the appended claims are intended to cover all such modifications and changes that fall within the true spirit of the disclosed subject matter.

1: A method comprising:
receiving a packet;
applying an Active Rule to the received Packet;
accessing a cached Condition Set Table, having at least one Condition Set, associated with the Active Rule;
for each Condition Set, having at least one Condition, in the Condition Set Table,
evaluating the Condition(s) in the Condition Set, and
determining if the Condition Set is met;
determining if the Active Rule is met; and
executing an Action Set associated with the Active Rule.

2: The method of claim 1, wherein applying an Active Rule to the received Packet includes:
parsing a cached Rules Tables, having a plurality of rules, to determine if a rule is pertinent to the received packet;
if so, making the pertinent rule the Active Rule.

3: The method of claim 2, wherein applying an Active Rule to the received Packet includes:
if more than one rule in the Rules Table is pertinent, performing the method of claim 1 for each pertinent rule.

4: The method of claim 2, wherein the received packet includes a source, a destination, and a protocol;
wherein the rules in the Rules Table includes a source, a destination, and a protocol; and
wherein determining if a rule is pertinent to the received packet includes: determining if the source of the received packet and the source of the rule are equivalent; determining if the destination of the received packet and the destination of the rule are equivalent;
determining if the protocol of the received packet and the protocol of the rule are equivalent;
if all three are equivalent, considering the rule pertinent to the received packet.

5: The method of claim 2, wherein applying an Active Rule to the received Packet includes:
selecting a rule from a Rules Table, having at least one rule; and
accessing a Rule Group from a Rules Group Table;
wherein the Rule Group includes a field to facilitate access to the first Condition Set associated with the rule, and a field to facilitate access to the first Action Set associated with the rule.

6: The method of claim 5, wherein accessing a cached Condition Set Table includes:
accessing the Condition Set Tables utilizing the Rule Group's field to facilitate access to the first Condition Set associated with the rule.

7: The method of claim 1, wherein each of the at least one Conditions includes pattern, and an opcode; and
wherein evaluating the Condition(s) in the Condition Set includes:
for each Condition,
comparing the pattern to the received packet in the manner dictated by the opcode, and
producing a Boolean value as a result of the comparison; an wherein determining if the Condition Set is met includes:
computing a single Boolean value utilizing the Boolean values resulting from evaluating the Condition(s).

8: The method of claim 7, wherein each of the at least one Conditions further includes at least one of the fields selected from a group including of the following:
a bit offset where the pattern is to be found,
a pattern mask to alter interpretation of the pattern,
a mask value to alter interpretation of received packet, and
a pattern length.

9: The method of claim 7, wherein each of the at least one Conditions further includes a flag to denote that the Condition has already been evaluated for the current received packet, and a value denoting the result of that evaluation.

10: The method of claim 7, wherein computing a single Boolean value utilizing the Boolean values resulting from evaluating the Condition(s) includes:
utilizing a 1-bit Condition Accumulator to logically AND, as each Condition's Boolean value is computed, the Boolean values resulting from evaluating the Condition(s).

11: The method of claim 7, wherein determining if the Active Rule is met includes:
computing a single Boolean value utilizing the Boolean values resulting from determining if the Condition Set is met.

12: The method of claim 1 1, wherein computing a single Boolean value utilizing the Boolean values resulting from determining if the Condition Set is met includes:
utilizing a 1-bit Condition Set Accumulator to logically OR, as each Condition Set's Boolean value is computed, the Boolean values resulting from determining if the Condition Set is met.

13: The method of claim 6, wherein evaluating the Condition(s) in the Condition Set includes:
utilizing the Condition Set Table to access a Condition Indirection Table, having a pointer to each Condition, wherein the pointers are grouped by Condition Set; and
utilizing the pointers to access a Condition Table having the Conditions.

14. The method of claim 13, wherein any Condition may be included by a plurality of Condition Sets.

15. The method of claim 13, wherein the Condition Indirection Table is stored within a Content Addressable Memory (CAM).

16. The method of claim 1, wherein executing an Action Set associated with the Active Rule includes:
accessing an Action Set having at least one Action; and
executing each Action within the Action Set.

17. The method of claim 16, wherein executing each Action includes performing one of the Actions selected from a group including the following:
altering the packet header,
altering the packet contents,
reporting information to a third party, and
changing the priority status of the packet.

18. The method of claim 16, wherein accessing an Action Set having at least one Action includes:
accessing a Rule Group having a pointer to the Action Set;
accessing an Action Set Table having a plurality of Action Sets; and
selecting an Action Set from the Action Set Table.

19. The method of claim 1, wherein the number of Conditions in a Condition Set is limited, at least in part, by the amount of information that can be read from a cache memory in one clock cycle.

20. The method of claim 1, wherein the number of Actions in an Action Set is limited, at least in part, by the amount of information that can be read from a cache memory in one clock cycle.

21. An apparatus comprising:
a micro-engine having a rule based action packet processing engine that is capable of processing a received packet;
a network processor core that is capable of resource management and control of the micro-engine;
a packet buffer to receive a packet; and
a cache memory to store data structures for the micro-engine.

22. The apparatus of claim 21, further including a plurality of micro-engines to process a plurality of received packets substantial simultaneously.

23. The apparatus of claim 21, wherein the micro-engine includes:
an ingress packet processing engine to receive a packet;
an egress packet processing engine to forward a processed packet; and
a Rule Based Action Packet Processing Engine that is capable of: applying an Active Rule to the received Packet;
accessing a cached Condition Set Table, having at least one Condition Set, associated with the Active Rule;
for each Condition Set, having at least one Condition, in the Condition Set Table,
evaluating the Condition(s) in the Condition Set, and
determining if the Condition Set is met;
determining if the Active Rule is met; and
executing an Action Set associated with the Active Rule.

24. The apparatus of claim 23, wherein the Rule Based Action Packet Processing Engine's capability to apply an Active Rule to the received Packet includes the capability to:
parse a cached Rules Tables, having a plurality of rules, to determine if a rule is pertinent to the received packet;
if so, make the pertinent rule the Active Rule.

25. The apparatus of claim 24, wherein the received packet includes a source, a destination, and a protocol;
wherein the rules in the Rules Table includes a source, a destination, and a protocol; and
wherein the Rule Based Action Packet Processing Engine's is capable of: determining if the source of the received packet and the source of the rule are equivalent; determining if the destination of the received packet and the destination of the rule are equivalent;
determining if the protocol of the received packet and the protocol of the rule are equivalent;
if all three are equivalent, considering the rule pertinent to the received packet.

26: The apparatus of claim 24, wherein the Rule Based Action Packet Processing Engine's is capable of, when applying an Active Rule to the received Packet:
selecting a rule from a Rules Table, having at least one rule; and
accessing a Rule Group from a Rules Group Table;
wherein the Rule Group includes a field to facilitate access to the first Condition Set associated with the rule, and a field to facilitate access to the first Action Set associated with the rule.

27: The apparatus of claim 23, wherein each of the at least one Conditions includes pattern, and an opcode; and
wherein the Rule Based Action Packet Processing Engine's is capable of, when evaluating the Condition(s) in the Condition Set:
for each Condition,
comparing the pattern to the received packet in the manner dictated by the opcode, and
producing a Boolean value as a result of the comparison; an wherein determining if the Condition Set is met includes:
computing a single Boolean value utilizing the Boolean values resulting from evaluating the Condition(s).

28: The apparatus of claim 27, wherein the Rule Based Action Packet Processing Engine includes a 1-bit Condition Accumulator; and
the Rule Based Action Packet Processing Engine is capable of, when computing a single Boolean value utilizing the Boolean values resulting from evaluating the Condition(s):
utilizing the 1-bit Condition Accumulator to logically AND, as each Condition's Boolean value is computed, the Boolean values resulting from evaluating the Condition(s).

29: The apparatus of claim 27, wherein the Rule Based Action Packet Processing Engine is capable of, when determining if the Active Rule is met:
computing a single Boolean value utilizing the Boolean values resulting from determining if the Condition Set is met.

30: The apparatus of claim 29, wherein the Rule Based Action Packet Processing Engine includes a 1-bit Condition Set Accumulator; and
the Rule Based Action Packet Processing Engine is capable of, when computing a single Boolean value utilizing the Boolean values resulting from determining if the Condition Set is met:
utilizing the 1-bit Condition Set Accumulator to logically OR, as each Condition Set's Boolean value is computed, the Boolean values resulting from determining if the Condition Set is met.

31: The apparatus of claim 23, wherein the Rule Based Action Packet Processing Engine is capable of
accessing the Condition Set Tables utilizing the Rule Group's field to facilitate access to the first Condition Set associated with the rule
utilizing the Condition Set Table to access a Condition Indirection Table, having a pointer to each Condition, wherein the pointers are grouped by Condition Set; and
utilizing the pointers to access a Condition Table having the Conditions; and wherein the Condition Set Table is stored as a data structure within the cache memory.

32: The apparatus of claim 31, wherein Micro-Engine includes a Content Addressable Memory (CAM); and
the Condition Indirection Table is stored within the Content Addressable Memory.

33: The apparatus of claim 23, wherein the Rule Based Action Packet Processing Engine is capable of, when executing an Action Set associated with the Active Rule:
accessing an Action Set having at least one Action; and
executing each Action within the Action Set; and
the Action Set is stored a data structure within the cache memory.

34: The apparatus of claim 33, wherein the Rule Based Action Packet Processing Engine is capable of performing one of the Actions selected from a group including the following:
altering the packet header,
altering the packet contents,
reporting information to a third party, and
changing the priority status of the packet.

35: The apparatus of claim 33, wherein the Rule Based Action Packet Processing Engine is capable of, when accessing an Action Set:
accessing a Rule Group having a pointer to the Action Set;
accessing an Action Set Table having a plurality of Action Sets; and
selecting an Action Set from the Action Set Table.

36: The apparatus of claim 23, wherein the number of Conditions in a Condition Set is limited, at least in part, by the amount of information that can be read from a cache memory in one clock cycle.

37: The apparatus of claim 23, wherein the number of Actions in an Action Set is limited, at least in part, by the amount of information that can be read from the cache memory in one clock cycle.

38: The apparatus of claim 35, wherein the cache memory includes a SRAM.

39: The apparatus of claim 38, wherein the packet buffer includes a DRAM.

40: The apparatus of claim 39, wherein the network processor core is further capable of receiving instructions via a generic programmable interface; and
the received instructions are capable of altering the Condition Set and the Action Set.

41: An article comprising:
a storage medium having a plurality of machine accessible instructions, wherein when the instructions are executed, the instructions provide for:
receiving a packet;
applying an Active Rule to the received Packet;
accessing a cached Condition Set Table, having at least one Condition Set, associated with the Active Rule;
for each Condition Set, having at least one Condition, in the Condition Set Table,
evaluating the Condition(s) in the Condition Set, and
determining if the Condition Set is met;
determining if the Active Rule is met; and
executing an Action Set associated with the Active Rule.

42: The article of claim 41, wherein the instructions providing for applying an Active Rule to the received Packet includes instructions providing for:
parsing a cached Rules Tables, having a plurality of rules, to determine if a rule is pertinent to the received packet;
if so, making the pertinent rule the Active Rule.

43: The article of claim 42, wherein the instructions providing for applying an Active Rule to the received Packet includes instructions providing for:
if more than one rule in the Rules Table is pertinent, performing the method of claim 1 for each pertinent rule.

44: The article of claim 42, wherein the received packet includes a source, a destination, and a protocol;
wherein the rules in the Rules Table includes a source, a destination, and a protocol; and
wherein the instructions providing for determining if a rule is pertinent to the received packet includes instructions providing for:
determining if the source of the received packet and the source of the rule are equivalent;
determining if the destination of the received packet and the destination of the rule are equivalent;
determining if the protocol of the received packet and the protocol of the rule are equivalent;
if all three are equivalent, considering the rule pertinent to the received packet.

45: The article of claim 42, wherein the instructions providing for applying an Active Rule to the received Packet includes instructions providing for:
selecting a rule from a Rules Table, having at least one rule; and
accessing a Rule Group from a Rules Group Table;
wherein the Rule Group includes a field to facilitate access to the first Condition Set associated with the rule, and a field to facilitate access to the first Action Set associated with the rule.

46: The article of claim 45, wherein the instructions providing for accessing a cached Condition Set Table includes instructions providing for:
accessing the Condition Set Tables utilizing the Rule Group's field to facilitate access to the first Condition Set associated with the rule.

47: The article of claim 41, wherein each of the at least one Conditions includes pattern, and an opcode; and
wherein the instructions providing for evaluating the Condition(s) in the Condition Set includes instructions providing for:
for each Condition,
comparing the pattern to the received packet in the manner dictated by the opcode, and
producing a Boolean value as a result of the comparison; an wherein determining if the Condition Set is met includes:
computing a single Boolean value utilizing the Boolean values resulting from evaluating the Condition(s).

48: The article of claim 47, wherein each of the at least one Conditions further includes at least one of the fields selected from a group including of the following:
a bit offset where the pattern is to be found,
a pattern mask to alter interpretation of the pattern,
a mask value to alter interpretation of received packet, and
a pattern length.

49: The article of claim 47, wherein each of the at least one Conditions further includes a flag to denote that the Condition has already been evaluated for the current received packet, and a value denoting the result of that evaluation.

50: The article of claim 47, wherein the instructions providing for computing a single Boolean value utilizing the Boolean values resulting from evaluating the Condition(s) includes instructions providing for:
utilizing a 1-bit Condition Accumulator to logically AND, as each Condition's Boolean value is computed, the Boolean values resulting from evaluating the Condition(s).

51: The article of claim 47, wherein the instructions providing for determining if the Active Rule is met includes instructions providing for:
computing a single Boolean value utilizing the Boolean values resulting from determining if the Condition Set is met.

52: The article of claim 51, wherein the instructions providing for computing a single Boolean value utilizing the Boolean values resulting from determining if the Condition Set is met includes instructions providing for:
utilizing a 1-bit Condition Set Accumulator to logically OR, as each Condition Set's Boolean value is computed, the Boolean values resulting from determining if the Condition Set is met.

53: The article of claim 46, wherein the instructions providing for evaluating the Condition(s) in the Condition Set includes instructions providing for:
utilizing the Condition Set Table to access a Condition Indirection Table, having a pointer to each Condition, wherein the pointers are grouped by Condition Set; and
utilizing the pointers to access a Condition Table having the Conditions.

54. The article of claim 53, wherein any Condition may be included by a plurality of Condition Sets.

55. The article of claim 53, wherein the Condition Indirection Table is stored within a Content Addressable Memory (CAM).

56. The article of claim 41, wherein the instructions providing for executing an Action Set associated with the Active Rule includes instructions providing for:
accessing an Action Set having at least one Action; and
executing each Action within the Action Set.

57. The article of claim 56, wherein the instructions providing for executing each Action includes instructions providing for performing one of the Actions selected from a group including the following:
altering the packet header,
altering the packet contents,
reporting information to a third party, and
changing the priority status of the packet.

58. The article of claim 56, wherein the instructions providing for accessing an Action Set having at least one Action includes instructions providing for:
accessing a Rule Group having a pointer to the Action Set;
accessing an Action Set Table having a plurality of Action Sets; and
selecting an Action Set from the Action Set Table.

59. The article of claim 41, wherein the number of Conditions in a Condition Set is limited, at least in part, by the amount of information that can be read from a cache memory in one clock cycle.

60. The article of claim 41, wherein the number of Actions in an Action Set is limited, at least in part, by the amount of information that can be read from a cache memory in one clock cycle.
